(19) United States
(12) Patent Application Publication
(10) Pub. No.: US 2026/0338237 A1
(43) Pub. Date: Oct. 29, 2026

(54) CONSTANT VELOCITY JOINT

(71) Applicants: SEOHAN INNOBILITY CO., LTD., Chungcheongbuk-do (KR); KOREA MOVENEX CO., LTD., Ulsan (KR)

(72) Inventors: Sung Hyun KIM, Hwaseong-si (KR); Jeong Lyul PARK, Hwaseong-si (KR); Chang Beom YU, Hwaseong-si (KR)

(73) Assignees: SEOHAN INNOBILITY CO., LTD., Chungcheongbuk-do (KR); KOREA MOVENEX CO., LTD., Ulsan (KR)

(21) Appl. No.: 19/544,988

(22) Filed: Feb. 19, 2026

(30) Foreign Application Priority Data
Feb. 25, 2025 (KR) 10-2025-0024122

(51) Int. Cl. F16D 3/224

(52) U.S. Cl. CPC F16D 3/224

(57) ABSTRACT

The present invention relates to a constant velocity joint, and more particularly, to a constant velocity joint capable of equal angular articulation that can significantly increase an articulation angle range, suppress track deformation, and prevent abnormal noise. The present invention may provide a constant velocity joint comprising: an outer race including a first outer race track and a second outer race track arranged on an opposite side of the first outer race track with respect to a virtual vertical centerline serving as an equiangular centerline; a first inner race including a first inner race track facing the first outer race track; a second inner race including a second inner race track facing the second outer race track; a first shaft inserted into and installed in the first inner race; and a second shaft inserted into and installed in the second inner race. The first inner race and the first shaft are disposed on an opposite side of the second inner race and the second shaft with respect to the virtual vertical centerline, and when articulation occurs, an articulation angle between the first shaft and the virtual vertical centerline is identical to an articulation angle between the second shaft and the virtual vertical centerline.

### CROSS-REFERENCE TO RELATED APPLICATIONS

A claim for priority under 35 U.S.C. § 119 is made to Korean Patent Application No. 10-2025-0024122 filed on Feb. 25, 2025, in the Korean Intellectual Property Office, the entire contents of which are hereby incorporated by reference.

### BACKGROUND OF THE INVENTION

### Field Of The Invention

The present invention relates to a constant velocity joint, and more particularly, to a constant velocity joint capable of equal angular articulation that can significantly increase an articulation angle range, suppress track deformation, and prevent abnormal noise.

### Description of the Related Art

Generally, a constant velocity joint is used to transmit rotational power (torque) between rotating shafts having different angles. For a propeller shaft with a small power transmission angle, a Hooke's joint or a flexible joint is typically used. In contrast, for a drive shaft of a front-wheel drive vehicle with a large power transmission angle, a constant velocity joint is employed.

As disclosed in Korean Patent Publication No. 10-2011-0125107, a ball-type joint installed on a wheel side (outboard side) of a shaft includes: a shaft rotated by receiving rotational power from a tripod-type joint; an inner race connected to one end of the shaft; an outer race disposed outside the inner race; a plurality of balls for transmitting the rotational power to the outer race; a cage for supporting the plurality of balls; a sensor ring installed outside the outer race; a boot having one end connected to the shaft and the other end connected to the outer race; and a clamping band for securing the boot.

In a conventional ball-type constant velocity joint for a vehicle, a cage and an inner race retain balls, and the balls are configured to move within grooves formed longitudinally on an inner peripheral surface of an outer race according to steering.

However, with the recent introduction of electric vehicles, the required driving torque has increased. In vehicle models requiring high-articulation joints for full turns, track deformation occurs under high-articulation conditions. This leads to a problem where abnormal noise is generated due to contact between the track and the inner or outer diameter of the cage.

### SUMMARY OF THE INVENTION

The present invention is contemplated to solve problems in the prior art mentioned above. Thus, it is an object of the present invention is to provide a constant velocity joint capable of significantly increasing an articulation angle range, suppressing track deformation, and preventing abnormal noise.

To achieve the above objects, the present invention may provide a constant velocity joint comprising: an outer race including a first outer race track and a second outer race track arranged on an opposite side of the first outer race track with respect to a virtual vertical centerline serving as an equiangular centerline; a first inner race including a first inner race track facing the first outer race track; a second inner race including a second inner race track facing the second outer race track; a first shaft inserted into and installed in the first inner race; and a second shaft inserted into and installed in the second inner race. The first inner race and the first shaft are disposed on an opposite side of the second inner race and the second shaft with respect to the virtual vertical centerline, and when articulation occurs, an articulation angle between the first shaft and the virtual vertical centerline is identical to an articulation angle between the second shaft and the virtual vertical centerline.

Additionally, the present invention may further include a connection joint provided between an end of the first shaft and an end of the second shaft within the outer race, the connection joint being configured to guide the articulation between the first shaft and the second shaft.

The present invention may further include: a first ball disposed between the first outer race track and the first inner race track; a first cage supporting the first ball; a second ball disposed between the second outer race track and the second inner race track; and a second cage supporting the second ball. Within the outer race, the first ball and the first cage may be symmetrically arranged with the second ball and the second cage with respect to a vertical centerline serving as an equiangular centerline.

In the present invention, the connection joint may include: a female joint movably coupled to an end of either the first shaft or the second shaft; and a male joint movably coupled to an end of the other of the first shaft or the second shaft and pivotally coupled to the female joint. The male joint may include an outer spherical portion, and the female joint may include a support portion having an inner spherical portion in which the outer spherical portion is inserted and accommodated to be pivotally supported.

In the present invention, first and second insertion holes into which the female joint and the male joint are respectively inserted may be provided in the first shaft and the second shaft. In the first and second insertion holes, first and second elastic members for elastically supporting a rear portion of the female joint and a rear portion of the male joint, respectively, may be provided.

In the present invention, each of the first and second insertion holes may include a large inner diameter portion and a small inner diameter portion. Each of the rear portions of the female joint and the male joint may include a large outer diameter portion and a small outer diameter portion. The elastic members are fixed by being press-fitted into the small inner diameter portion and the small outer diameter portion, respectively. To allow the large outer diameter portion to move within the large inner diameter portion according to the articulation of the constant velocity joint, an inner diameter of the large inner diameter portion may be formed larger than an outer diameter of the large outer diameter portion.

When articulation occurs, the male joint and the female joint may relatively move with respect to the first and second shafts by the first and second elastic members, so as to be arranged in a direction away from the ends of the first and second shafts.

A diameter of the spherical portion of the male joint may be formed smaller than an inner diameter of a coupling hole at a center of the first inner race or the second inner race. Similarly, a diameter of the support portion of the female joint may be formed smaller than the inner diameter of the coupling hole at the center of the first inner race or the second inner race.

A space in which the first outer race track is formed and a space in which the second outer race track is formed may be in communication with each other, and the connection joint may be disposed in the communication space.

According to another aspect of the present invention, there is provided a constant velocity joint comprising: an outer race including a first outer race track and a second outer race track arranged on an opposite side of the first outer race track with respect to a virtual vertical centerline serving as an equiangular centerline; a first inner race and a second inner race disposed inside the outer race; a first shaft inserted into and installed in the first inner race; and a second shaft inserted into and installed in the second inner race. The first inner race and the first shaft are disposed on an opposite side of the second inner race and the second shaft with respect to the virtual vertical centerline, and the constant velocity joint further includes a connection joint provided between an end of the first shaft and an end of the second shaft within the outer race to guide articulation between the first shaft and the second shaft.

The connection joint may include: a female joint movably coupled to an end of either the first shaft or the second shaft; and a male joint movably coupled to an end of the other of the first shaft or the second shaft and pivotally coupled to the female joint. The male joint includes an outer spherical portion, and the female joint includes a support portion having an inner spherical portion in which the outer spherical portion is inserted and accommodated to be pivotally supported.

In the first shaft and the second shaft, a first insertion hole and a second insertion hole into which the female joint and the male joint are respectively inserted may be provided. In the first insertion hole and the second insertion hole, a first elastic member and a second elastic member for elastically supporting a rear portion of the female joint and a rear portion of the male joint, respectively, may be provided.

Each of the first and second insertion holes may include a large inner diameter portion and a small inner diameter portion. Each of the rear portions of the female joint and the male joint may include a large outer diameter portion and a small outer diameter portion. The elastic members are fixed by being press-fitted into the small inner diameter portion and the small outer diameter portion, respectively. To allow the large outer diameter portion to move within the large inner diameter portion according to the articulation of the constant velocity joint, an inner diameter of the large inner diameter portion may be formed larger than an outer diameter of the large outer diameter portion.

When articulation occurs, an articulation angle between the first shaft and the virtual vertical centerline may be identical to an articulation angle between the second shaft and the vertical centerline.

When articulation occurs, the male joint and the female joint may relatively move with respect to the first and second shafts by the first and second elastic members, so as to be arranged in a direction away from the ends of the first and second shafts.

A diameter of the spherical portion of the male joint may be formed smaller than an inner diameter of a coupling hole at a center of the first inner race or the second inner race. Similarly, a diameter of the support portion of the female joint may be formed smaller than the inner diameter of the coupling hole at the center of the first inner race or the second inner race.

A space in which the first outer race track is formed and a space in which the second outer race track is formed may be in communication with each other, and the connection joint may be disposed in the communication space.

Details of examples or implementations will be described in the following with reference to the accompanying drawings. Other features will be apparent from the description and drawings, and from the claims.

### BRIEF DESCRIPTION OF THE DRAWINGS

The present invention will become more fully understood from the detailed description given below and the accompanying drawings, which are given by illustration only, and thus are not intended to limit the scope of the present invention, wherein:

FIG. 1 is a perspective view of the present invention. ;

FIG. 2 is a side sectional view of the present invention. ;

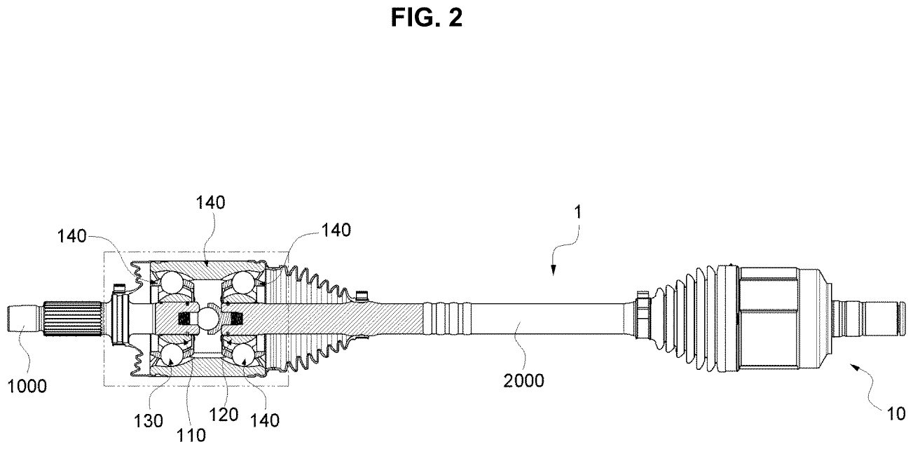

FIG. 3 is an enlarged side sectional view of FIG. 2;

FIG. 4 is an enlarged side sectional view of a connection joint;

FIG. 5 is a side sectional view sectional view in a state without articulation in the present invention. ;

FIG. 6 is a side sectional view in a horizontal state without articulation in the present invention;

FIG. 7 is a side sectional view in an articulated state in the present invention. ;

FIG. 8 is an enlarged side sectional view of the connection joint in the articulated state.

### DETAILED DESCRIPTION OF THE PREFERRED EMBODIMENT

Description for the present invention will now be given in detail according to examples disclosed herein, with reference to the accompanying drawings.

For the sake of a brief description with reference to the drawings, the same or equivalent components may be provided with the same reference numbers, and description thereof will not be repeated. In the following, any conventional art which is well-known to one of ordinary skill in the relevant art has generally been omitted for the sake of brevity. The accompanying drawings are used to help easily understand various technical features and it should be understood that the examples presented herein are not limited by the accompanying drawings. As such, the present invention should be construed to extend to any alterations, equivalents, and substitutes in addition to those which are particularly set out in the accompanying drawings.

A singular representation may include a plural representation unless it represents a definitely different meaning from the context.

It will be understood that although the terms “first,” “second,” etc., may be used herein to describe various components, these components should not be limited by these terms. These terms are only used to distinguish one component from another component.

The term “and/or” includes any combination of a plurality of related listed items or any one of a plurality of related listed items.

It should be understood that when a component is referred to as being “connected to” or “coupled to” another component, this component may be directly connected to or coupled to another component, or any intervening components may be present between the components. In contrast, when a component is referred to as being “directly connected to” or “directly coupled to” another component, there are no intervening components present.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present invention includes any combinations of features, numerals, steps, operations, components, parts and the like partially omitted from the related or involved features, numerals, steps, operations, components, and parts described using the aforementioned terms unless deviating from the intentions of the original disclosure.

Hereinafter, embodiments will now be described in detail with reference to the accompanying drawings, wherein identical or corresponding components, regardless of reference numerals, are assigned the same reference numerals and redundant descriptions thereof are omitted.

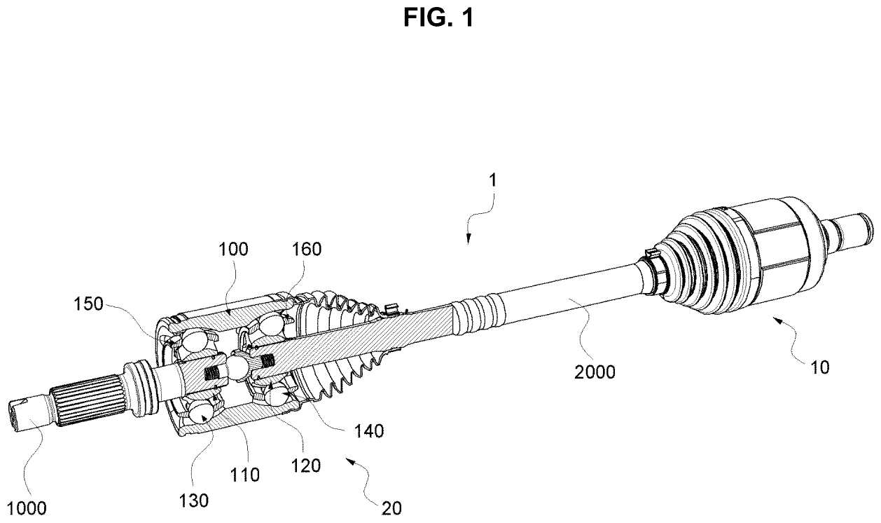

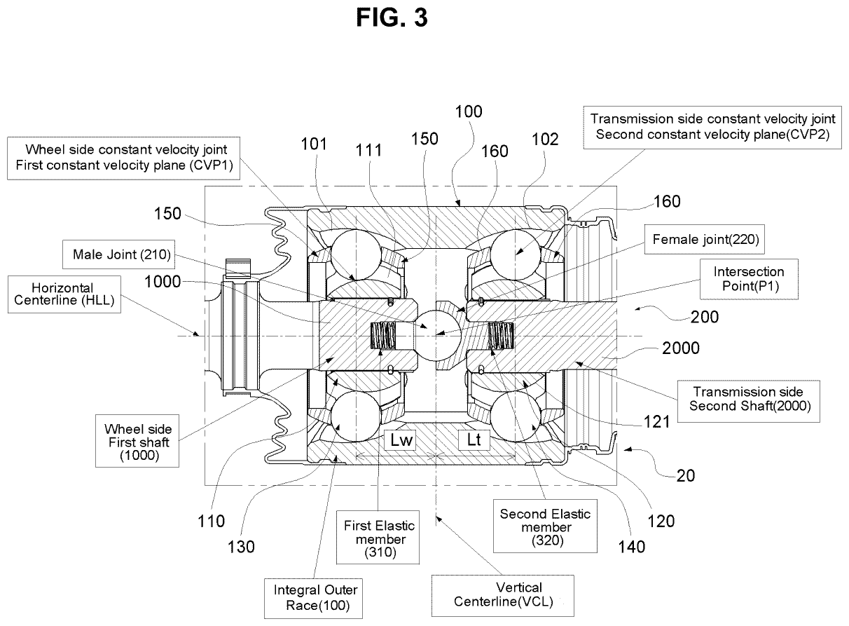

As shown in FIG. 1 and FIG. 3, a half shaft 1 performs a power transmission function in a power transmission system connected from a transmission to a wheel. The half shaft 1 may include an inboard constant velocity joint 10 connected to the transmission side, an outboard constant velocity joint 20 connected to the wheel side; a first shaft 1000 connecting the inboard constant velocity joint 10 and the wheel, and a second shaft 2000 connecting the outboard constant velocity joint 20 and the inboard constant velocity joint 10

The present disclosure relates to an inboard constant velocity joint 20. As will be described later, a first shaft 1000 and a second shaft 2000 are connected to a first inner race 110 and a second inner race 120 located within an outer race. The inboard constant velocity joint 20 according to the present disclosure is characterized by being equiangularly articulated with respect to a virtual vertical centerline (to be described later) of the outer race, which serves as an equiangular centerline, so as to ultimately achieve an overall higher angle of articulation than before.

Hereinafter, the constant velocity joint 20 defines an inboard constant velocity joint.

A constant velocity joint 20 according to the present disclosure may include: an outer race 100; a first inner race 110 and a second inner race 120 disposed inside the outer race 100; a first ball 130 and a second ball 140 disposed between the outer race 100 and the first and second inner races 110, 120; and a first cage 150 and a second cage 160 supporting the first ball 130 and the second ball 140, respectively.

The outer race 100 may be provided in a cylindrical shape having a hollow portion, being open in front and rear directions, and communicating in the front and rear directions. On an inner surface of the outer race 100, a plurality of first outer race tracks 101 and a plurality of second outer race tracks 102 arranged on an opposite side of the first outer race tracks 101 with respect to a virtual vertical centerline VCL serving as an equiangular centerline may be provided.

Here, the outer race 100 is preferably manufactured as an integral type through forging. That is, it is preferable that a portion where the first outer race tracks 101 are disposed and a portion where the second outer race tracks 102 are disposed are integrally formed as one, rather than being connected by welding or other coupling tools. However, depending on the situation, it is also possible to couple them by welding or other coupling tools.

Here, the first outer race tracks 101 and the second outer race tracks 102 may be symmetrical with respect to a virtual vertical centerline VCL of the outer race 100, which serves as an equiangular centerline.

Meanwhile, an internal space of the outer race 100 where the first outer race tracks 101 are formed and an internal space of the outer race 100 where the second outer race tracks 102 are formed are in communication with each other. This communication space is a space in which a connection joint 200, to be described later, is disposed.

The inner race may include a first inner race 110 including a plurality of first inner race tracks 111 facing the first outer race tracks 101, and a second inner race 120 including a plurality of second inner race tracks 112 facing the second outer race tracks 102. Additionally, the shaft may includes a first shaft 1000 inserted into and installed in the first inner race 110, and a second shaft 2000 inserted into and installed in the second inner race 120.

Meanwhile, the constant velocity joint may further include a plurality of first balls 130 disposed between the first outer race tracks 101 and the first inner race tracks 111, a first cage 150 supporting the first balls 130, and a plurality of second balls 140 disposed between the second outer race tracks 102 and the second inner race tracks 112; and a second cage 160 supporting the second balls 140.

The first inner race 110, the first shaft 1000, the first balls 130, and the first cage 150 may be disposed on an opposite side of and symmetrically to the second inner race 120, the second shaft 2000, the second balls 140, and the second cage 160 with respect to the vertical centerline VCL of the outer race 100, which serves as an equiangular centerline.

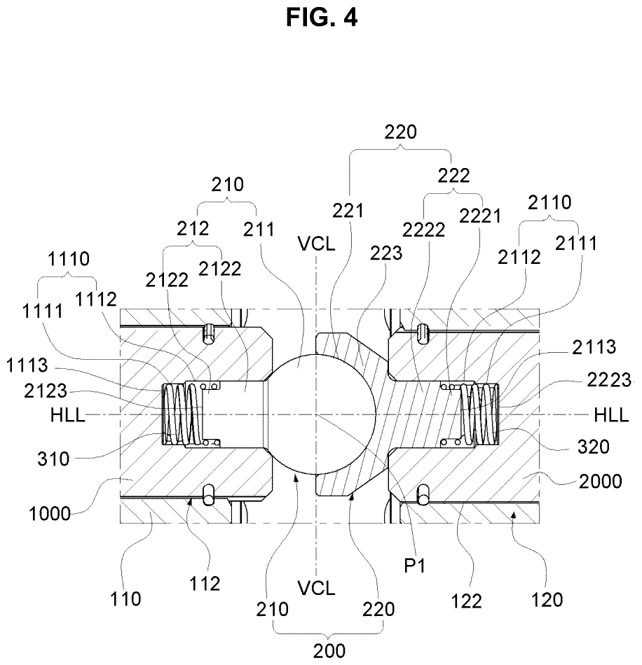

Meanwhile, as shown in FIG. 3 and FIG. 4, a connection joint 200 may be further provided. The connection joint 200 is provided between an end of the first shaft 1000 and an end of the second shaft 2000 inside the outer race 100 to guide and induce articulation between the first shaft 1000 and the second shaft 2000.

The connection joint 200 may include a female joint 220 movably coupled to an end of the second shaft 2000, and a male joint 210 movably coupled to an end of the first shaft 1000 and pivotally coupled to the female joint 220.

Alternatively, the male joint 210 may be disposed on the first shaft 1000 and the female joint 220 may be disposed on the second shaft 2000, and their positions may be interchanged with each other depending on the situation.

Hereinafter, a description will be given by taking an example in which the male joint 210 is installed at the end of the first shaft 1000 and the female joint 220 is installed at the end of the second shaft 2000, but the present disclosure is not limited thereto.

The male joint 210 includes an outer spherical portion 211, and a first insertion portion 212 connected to the outer spherical portion 211 and inserted and fitted into a first insertion hole 1110 provided at the end of the the first shaft 1000.

The female joint 220 may include a support portion 223 having an inner spherical portion 221 in which the outer spherical portion 211 is inserted and accommodated to be pivotally supported, and a second insertion portion 222 connected to the support portion 223 and inserted and fitted into a second insertion hole 2110 provided at the end of the second shaft 2000.

In the first insertion hole 1110 and the second insertion hole 2110, a first elastic member 310 and a second elastic member 320 in a form of a coil spring may be provided to elastically support a rear portion of the female joint 220 and a rear portion of the male joint 210, respectively.

The first insertion hole 1110 and the second insertion hole 2110 may include a large inner diameter portion 1112, 2112 and a small inner diameter portion 1111, 2111, respectively. The rear portion of the female joint 220 and the rear portion of the male joint 210 may include a large outer diameter portion 2122, 2222 and a small outer diameter portion 2121, 2221.

Additionally, the first elastic member 310 and the second elastic member 320 may be fixed by being press-fitted into the small inner diameter portions 1111, 2111 and the small outer diameter portions 2121, 2221, respectively. To allow the large outer diameter portions 2122, 2222 to move within the large inner diameter portions 1112, 2112 according to the articulation of the constant velocity joint 20, it is preferable that an inner diameter of the large inner diameter portions 1112, 2112 is formed larger than an outer diameter of the large outer diameter portions 2122, 2222.

First, in a state where the first inner race 110, the second inner race 120, the first balls 130, the second balls 140, the first cage 150, and the second cage 160 are assembled to the outer race 100, the first shaft 1000 to which the male joint 210 is coupled is inserted into a first coupling hole 112 of the first inner race 110 from one side of the outer race 100.

Then, from the other side of the outer race 100, the second shaft 2000 to which the female joint 220 is coupled is inserted into a second coupling hole 122 of the second inner race 120. If an outer diameter of the outer spherical portion 211 of the male joint 210 or an outer diameter of the support portion 223 of the female joint 220 is larger than inner diameters of the first coupling hole 112 and the second coupling hole 122, they will be caught, making insertion impossible.

Accordingly, it is preferable that a diameter of the outer spherical portion 211 of the male joint 210 is formed smaller than an inner diameter of the first coupling hole 112 at the center of the first inner race 110 (or the second inner race 120 if positions are interchanged), and a diameter of the support portion 223 of the female joint 220 is formed smaller than an inner diameter of the second coupling hole 122 at the center of the first inner race 110 (or the second inner race 120 if positions are interchanged)

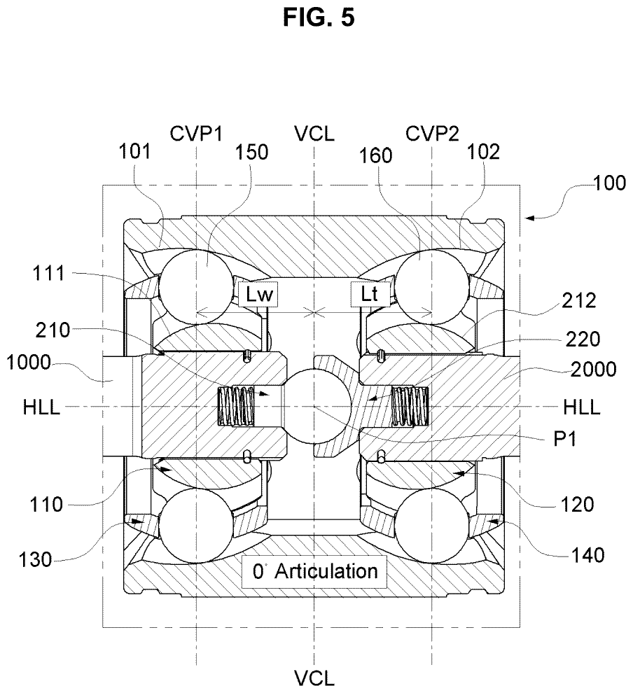

As shown in FIG. 3 to FIG. 5, when articulation of the constant velocity joint 20 of the present invention does not occur, a center of the outer spherical portion 211 of the male joint 210 may be disposed at an intersection point P1 where a virtual vertical centerline VCL in the outer race 100 and a virtual horizontal centerline HLL (rotation axes of the outer race 100 and the first shaft 1000 and the second shaft 2000 when not articulated) intersect.

In this state, the first shaft 1000 and the second shaft 2000 may be aligned in a line on the virtual horizontal centerline HLL. Since the first insertion portion 212 of the male joint 210 is maximally inserted into the first insertion hole 1110 of the first shaft 1000, a distance between a rear wall 1113 of the first insertion hole 1110 and a rear surface 2123 of the first insertion portion 212 may be minimized.

In this state, a connection portion between the outer spherical portion 211 and the first insertion portion 212 of the male joint 210 may be disposed near an entrance edge of the first insertion hole 1110.

At the same time, the second insertion portion 222 of the female joint 220 is maximally inserted into the second insertion hole 2110 of the second shaft 2000, so that a distance between a rear wall of the second insertion hole 2110 and a rear surface 2223 of the second insertion portion 222 may be minimized. Additionally, in this state, a connection portion between the support portion 223 and the second insertion portion 222 of the female joint 220 may be disposed near an entrance edge of the second insertion hole 2110.

A distance between the first constant velocity plane CVP1 and the vertical centerline VCL of the outer race 100 is defined as Lw. The first constant velocity plane CVP1 may be defined as a constant velocity plane formed by the first balls 130 arranged between the first inner race tracks 111 and the first outer race tracks 101 disposed on the wheel side.

Additionally, a distance between the second constant velocity plane CVP2 and the vertical centerline VCL is defined as Lt. The second constant velocity plane CVP2 may be defined as a constant velocity plane formed by the second balls 140 arranged between the second inner race tracks 112 and the second outer race tracks 102 disposed on the transmission side.

In the state without articulation, Lw and Lt maintain a minimum state.

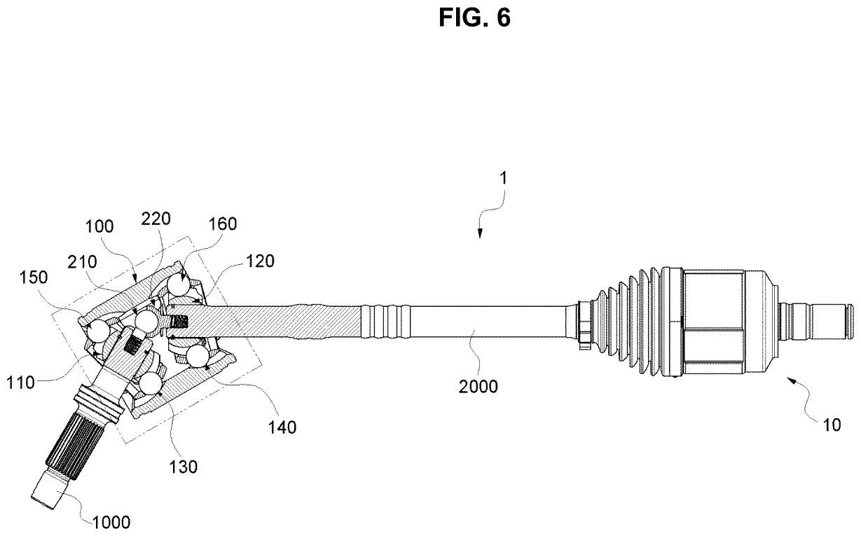

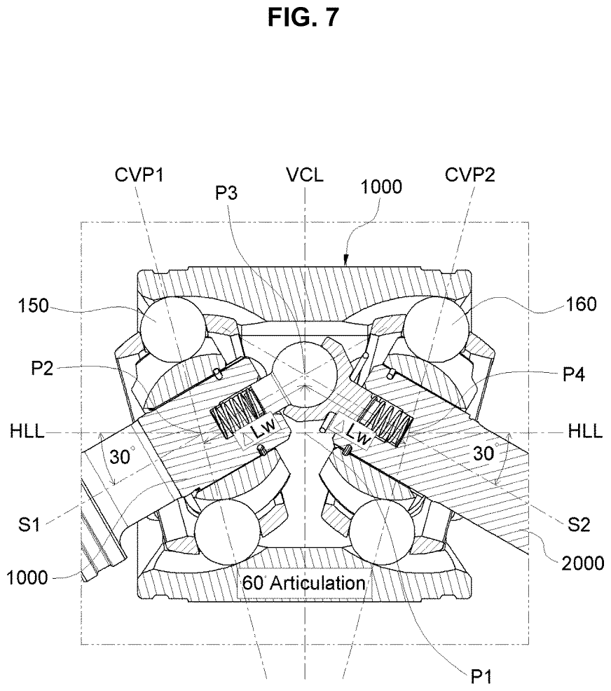

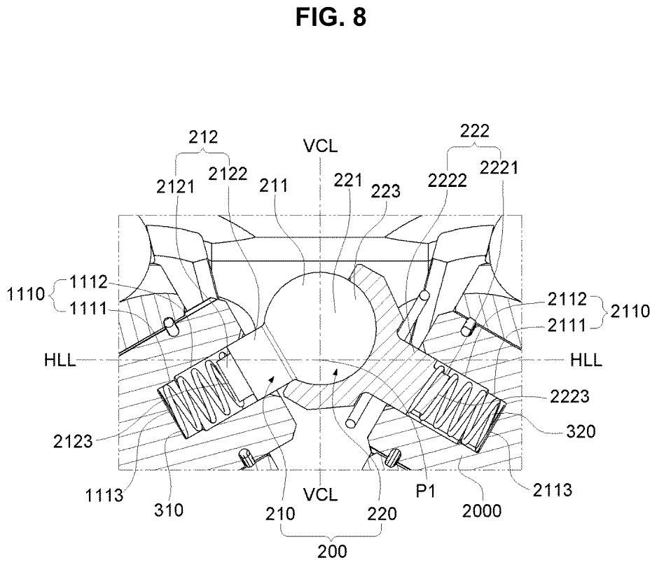

FIG. 6 is an overall view showing the articulation of an (outboard) constant velocity joint 20 in a half shaft 1; FIG. 7 is an enlarged sectional view of the articulated region (Region B) of FIG. 6; and FIG. 8 is a sectional view showing a layout of the connection joint 200 during articulation.

As shown in FIG. 6 and FIG. 7, when articulation occurs, an articulation angle between the first shaft 1000 and a virtual vertical centerline VCL (an equiangular centerline) perpendicular to a longitudinal direction of the outer race 100 (e.g., 30° on the left) and an articulation angle between the second shaft 2000 and the vertical centerline VCL (30° on the right) may be implemented to be identical.

Accordingly, a final combined articulation angle between the first shaft 1000 and the second shaft 2000 becomes 60°, thereby implementing a significantly increased articulation amount compared to a conventional articulation amount (e.g., 40 to 45°) of a conventional outboard constant velocity joint.

In addition, when the first shaft 1000 and the second shaft 2000 are articulated, the male joint 210 and the female joint 220 may be moved relative to the first shaft 1000 and the second shaft 2000 by the first elastic member 310 and the second elastic member 320, so as to be arranged in a direction moving away from the ends of the first shaft 1000 and the second shaft 2000.

And a movement direction of the male joint 210 and the female joint 220 may be formed along a hypotenuse (inclined line) tilted by an articulation angle with respect to the horizontal centerline HLL.

In particular, in a horizontal state before articulation, a center of the outer spherical portion 211 of the male joint 210 was at an intersection point of the vertical centerline VCL and the horizontal centerline HLL (a rotation axis of the outer race) of the outer race 100. However, as articulation occurs, the male joint 210 and the female joint 220 move in an upward direction (or downward direction), and especially the outer spherical portion 211 of the male joint 210 moves along the vertical centerline VCL to be adjacent to an inner surface of the outer race 100.

As previously described, the male joint 210 and the female joint 220 are moved relative to the first shaft 1000 and the second shaft 2000 by the first elastic member 310 and the second elastic member 320 to be arranged in a direction moving away from the ends of the first shaft 1000 and the second shaft 2000.

In this case, a distance between a first constant velocity plane CVP1 (formed by the first balls 130 arranged between the first inner race tracks 111 and the first outer race tracks 101 disposed on the wheel side) and the vertical centerline VCL of the outer race 100 is defined as ΔLw (ΔLw>Lw).

That is, the distance between the first constant velocity plane CVP1 and the vertical centerline VCL during articulation increases more than the distance between the first constant velocity plane CVP1 and the vertical centerline VCL in the state without articulation.

Additionally, a distance between a second constant velocity plane CVP2 (formed by the second balls 140 arranged between the second inner race tracks 112 and the second outer race tracks 102 disposed on the transmission side) and the vertical centerline VCL is defined as ΔLt (ΔLt>Lt).

ΔLw may also be defined as a distance between an intersection point P2 of a rotation center axis S1 of the first shaft 1000 and the first constant velocity plane CVP1, and an intersection point P3 of the rotation center axis S1 of the first shaft 1000 and the vertical centerline VCL of the outer race 100.

In addition, the line of ΔLw may correspond to a hypotenuse (inclined line) of a left right-angled triangle (a virtual right-angled triangle connecting the intersection point P2 of the rotation center axis S1 of the first shaft 1000 and the first constant velocity plane CVP1, the intersection point P3 of the rotation center axis S1 and the vertical centerline VCL of the outer race 100, and an intersection point P1 of the vertical centerline VCL and a horizontal centerline HL of the outer race 100).

ΔLt may also be defined as a distance between an intersection point P4 of a rotation center axis S2 of the second shaft 2000 and the second constant velocity plane CVP2, and the intersection point P3 of the rotation center axis S2 of the second shaft 2000 and the vertical centerline VCL of the outer race 100.

In addition, the line ΔLt may correspond to a hypotenuse (inclined line) of a right right-angled triangle (a virtual right-angled triangle connecting the intersection point P4 of the rotation center axis S2 of the second shaft 2000 and the second constant velocity plane CVP2, the intersection point P3 of the rotation center axis S2 and the vertical centerline VCL of the outer race 100, and the intersection point P1 of the vertical centerline VCL and the horizontal centerline HLL of the outer race 100).

These hypotenuses (inclined lines) are longer than the length of the bottom horizontal line of each right-angled triangle.

The distance between the first constant velocity plane CVP1 and the vertical centerline VCL of the outer race 100 during articulation (the length of the hypotenuse) increases compared to the distance between the first constant velocity plane CVP1 and the vertical centerline VCL in the state without articulation (the length of the bottom horizontal line). This is because a displacement (ΔLw−Lw=Δ) of the male joint 210 and the female joint 220 occurs due to the restoring force or repulsive force of the first elastic member 310 and the second elastic member 320 during articulation.

In conclusion, according to the present invention, the first shaft 1000 and the second shaft 2000 are simultaneously articulated with respect to the outer race 100 based on the spherical pivot coupling of the male joint 210 and the female joint 220. Since a total articulation amount between the first shaft 1000 and the second shaft 2000 can be significantly increased compared to a conventional constant velocity joint (an outboard constant velocity joint), a maximum articulation amount can be increased. In addition, in such a structure, an amount by which the first inner race tracks 111, the second inner race tracks 112, the first outer race tracks 101, and the second outer race tracks 102 surround the first balls 130 and the second balls 140 can be increased, thereby providing advantages of suppressing track deformation and suppressing the occurrence of abnormal noise.

According to the present invention, the articulation amount of the constant velocity joint is significantly increased, enabling stable power transmission even in vehicles requiring high articulation angles.

The balance of the joint is maintained by symmetrically maintaining the articulation angles of the shafts, and unnecessary deformation or wear can be minimized. Additionally, by adding the connection joint, the articulation of the shafts is naturally induced, and impact or friction that may occur during articulation can be reduced.

While ensuring smooth operation inside the joint, stability during the articulation process can be improved, and by symmetrically arranging the balls and the cages, balance is maintained within the joint to prevent friction or uneven wear.

Furthermore, durability of the joint is improved by suppressing track deformation, and the occurrence of abnormal noise can be prevented.”

By the coupling structure of the male joint and the female joint, the articulation of the shafts can be induced more smoothly; since the outer spherical portion and the inner spherical portion are pivotally supported, smooth rotation is possible during articulation, and damage to parts can be reduced.

In particular, the male joint and the female joint move relatively during articulation to allow smooth operation, preventing overload that occurs during articulation and reducing damage to the joint by maintaining balance during the articulation process.

By appropriately designing the sizes of the male joint and the female joint, assembly convenience is improved, and smooth operation during articulation becomes possible.

The elastic members inside the insertion holes assist the relative movement of the joint to serve as shock absorbers during articulation, reducing vibration and noise and increasing the durability of the joint.

By the size difference between the large inner diameter portion and the large outer diameter portion, the elastic members operate flexibly, enabling smooth movement during articulation.

Interference between parts can be reduced and durability can be increased; specifically, by minimizing unnecessary interference inside the joint, durability can be enhanced.

By designing the spaces inside the outer race to communicate with each other, the connection joint is smoothly disposed, articulation can be performed more smoothly, friction between parts is reduced, and structural stability during articulation can be improved.”

Although a number of examples have been described, it should be understood that other modifications and implementations can be devised by those skilled in the art that will fall within the spirit and scope of the principles of the present invention. More particularly, various variations and modifications in the structure or the configuration are possible within the scope of the disclosure, the drawings, and the appended claims. In addition to variations and modifications in the configuration, alternative uses will also be apparent to those skilled in the art.

What is claimed is:

1. A constant velocity joint, comprising:
an outer race including a first outer race track and a second outer race track arranged on an opposite side of the first outer race track with respect to a virtual vertical centerline serving as an equiangular centerline;
a first inner race including a first inner race track facing the first outer race track;
a second inner race including a second inner race track facing the second outer race track;
a first shaft installed by being inserted into the first inner race; and
a second shaft installed by being inserted into the second inner race,
wherein the first inner race and the first shaft are disposed on an opposite side of the second inner race and the second shaft based on the virtual vertical centerline serving as the equiangular centerline, and
wherein, when articulation occurs, an articulation angle between the first shaft and the virtual vertical centerline is identical to an articulation angle between the second shaft and the vertical centerline.

2. The constant velocity joint of claim 1, further comprising a connection joint provided between an end of the first shaft and an end of the second shaft inside the outer race to guide articulation between the first shaft and the second shaft.

3. The constant velocity joint of claim 1, comprising a first ball disposed between the first outer race track and the first inner race track, a first cage supporting the first ball, a second ball disposed between the second outer race track and the second inner race track, and a second cage supporting the second ball, wherein the first ball and the first cage are arranged symmetrically with the second ball and the second cage with respect to the vertical centerline serving as the equiangular centerline within the outer race.

4. The constant velocity joint of claim 2, wherein the connection joint includes: a female joint movably coupled to one end of either the first shaft or the second shaft; and a male joint movably coupled to the other end of the first shaft or the second shaft and pivotally coupled to the female joint, wherein the male joint includes an outer spherical portion, and wherein the female joint includes a support portion having an inner spherical portion in which the outer spherical portion is inserted and received to be pivotally supported.

5. The constant velocity joint of claim 4, wherein a first insertion hole and a second insertion hole into which the female joint and the male joint are respectively inserted are provided in the first shaft and the second shaft, and wherein a first elastic member and a second elastic member are provided in the first insertion hole and the second insertion hole, respectively, to elastically support a rear of the female joint and a rear of the male joint.

6. The constant velocity joint of claim 5, wherein each of the first insertion hole and the second insertion hole includes a large inner diameter portion and a small inner diameter portion, wherein each of the rear of the female joint and the rear of the male joint includes a large outer diameter portion and a small outer diameter portion, wherein the elastic members are respectively press-fitted and fixed to the small inner diameter portion and the small outer diameter portion, and wherein an inner diameter of the large inner diameter portion is formed larger than an outer diameter of the large outer diameter portion so that the large outer diameter portion is movable within the large inner diameter portion according to articulation of the constant velocity joint.

7. The constant velocity joint of claim 5, wherein, when articulation occurs, the male joint and the female joint move relatively with respect to the first and second shafts by the first and second elastic members to be arranged in a direction moving away from the ends of the first and second shafts.

8. The constant velocity joint of claim 4, wherein a diameter of the spherical portion of the male joint is formed smaller than an inner diameter of a coupling hole at a center of the first inner race or the second inner race, and wherein a diameter of the support portion of the female joint is formed smaller than an inner diameter of the coupling hole at the center of the first inner race or the second inner race.

9. The constant velocity joint of claim 2, wherein a space in which the first outer race track is formed and a space in which the second outer race track is formed communicate with each other, and the connection joint is disposed in the communication space.

10. A constant velocity joint, comprising:
an outer race including a first outer race track and a second outer race track arranged on an opposite side of the first outer race track with respect to a virtual vertical centerline serving as an equiangular centerline;
a first inner race and a second inner race disposed inside the outer race; a first shaft installed by being inserted into the first inner race; and a second shaft installed by being inserted into the second inner race,
wherein the first inner race and the first shaft are disposed on an opposite side of the second inner race and the second shaft based on the virtual vertical centerline serving as the equiangular centerline, and
further comprising a connection joint provided between an end of the first shaft and an end of the second shaft inside the outer race to guide articulation between the first shaft and the second shaft.

11. The constant velocity joint of claim 10, wherein the connection joint includes:
a female joint movably coupled to one end of either the first shaft or the second shaft; and
a male joint movably coupled to the other end of the first shaft or the second shaft and pivotally coupled to the female joint,
wherein the male joint includes an outer spherical portion, and wherein the female joint includes a support portion having an inner spherical portion in which the outer spherical portion is inserted and received to be pivotally supported.

12. The constant velocity joint of claim 11,
wherein a first insertion hole and a second insertion hole into which the female joint and the male joint are respectively inserted are provided in the first shaft and the second shaft, and wherein a first elastic member and a second elastic member are provided in the first insertion hole and the second insertion hole, respectively, to elastically support a rear of the female joint and a rear of the male joint.

13. The constant velocity joint of claim 12,
wherein each of the first insertion hole and the second insertion hole includes a large inner diameter portion and a small inner diameter portion,
wherein each of the rear of the female joint and the rear of the male joint includes a large outer diameter portion and a small outer diameter portion,
wherein the elastic members are respectively press-fitted and fixed to the small inner diameter portion and the small outer diameter portion, and
wherein an inner diameter of the large inner diameter portion is formed larger than an outer diameter of the large outer diameter portion so that the large outer diameter portion is movable within the large inner diameter portion according to articulation of the constant velocity joint.

14. The constant velocity joint of claim 10,
wherein, when articulation occurs, an articulation angle between the first shaft and the virtual vertical centerline is identical to an articulation angle between the second shaft and the vertical centerline.

15. The constant velocity joint of claim 14,
wherein, when articulation occurs, the male joint and the female joint move relatively with respect to the first and second shafts to be arranged in a direction moving away from the ends of the first and second shafts.

16. The constant velocity joint of claim 14,
wherein, when articulation occurs, the male joint and the female joint move relatively with respect to the first and second shafts by the first and second elastic members to be arranged in a direction moving away from the ends of the first and second shafts.

17. The constant velocity joint of claim 11,
wherein a diameter of the spherical portion of the male joint is formed smaller than an inner diameter of a coupling hole at a center of the first inner race or the second inner race, and wherein a diameter of the support portion of the female joint is formed smaller than an inner diameter of the coupling hole at the center of the first inner race or the second inner race.

18. The constant velocity joint of claim 10,
wherein a space in which the first outer race track is formed and a space in which the second outer race track is formed communicate with each other, and the connection joint is disposed in the communication space.
